(19) United States
(12) Patent Application Publication
(10) Pub. No.: US 2022/0362852 A1
(43) Pub. Date: Nov. 17, 2022

(54) ADDITIVE METHOD OF PRODUCTION WITH CURING

(71) Applicant: Flender GmbH, 46395 Bocholt (DE)

(72) Inventor: RALF MARTIN DINTER, Gelsenkirchen (DE)

(73) Assignee: Flender GmbH, 46395 Bocholt (DE)

(21) Appl. No.: 17/763,086

(22) PCT Filed: Aug. 10, 2020
(86) PCT No.: PCT/EP2020/072375

§ 371 Date: Mar. 23, 2022

(30) Foreign Application Priority Data
Sep. 27, 2019 (EP) 19200117.0

(51) Int. Cl. B22F 10/28; B22F 10/36; B22F 5/08

(52) U.S. Cl. CPC B22F 10/28; B22F 10/36; B22F 5/08; B33Y 10/00

(57) ABSTRACT

In a process for additive manufacturing of a machine component, a hardening agent is added to a base material of a material layer in locally adjustable fashion, and the material layer is irradiated with a laser to effect local melting of the material layer such that the hardening agent is at least embedded in the base material as the material layer is irradiated with the laser.

The invention relates to an additive manufacturing process for machine components comprising an integrated hardening. The invention further relates to a computer program product with which the process according to the invention is performable. The invention further relates to a control unit comprising such a computer program product and to a manufacturing apparatus provided with such a control unit. The invention further relates to a machine component producible in particular with the process according to the invention.

Published patent application DE 10 2004 008 054 A1 discloses a process for producing a three-dimensional article in which a metal powder layer is produced. The metal powder layer is subjected to a laser beam to melt the metal powder layer. A metal powder composition including iron-based powder material, a nickel and/or nickel alloy powder material, a copper and/or copper alloy powder material, and a graphite powder material is used.

Many technical fields have the objective of producing even mechanically highly stressed machine components by additive manufacturing. A particular aim is to produce machine components requiring high hardness by additive manufacturing. A simultaneous objective is that of simplifying the production of such mechanically highly stressed machine components and simultaneously increasing the constructional freedom in the design of such machine components. The problem addressed by the present invention is that of providing an option for producing demanding machine components by additive manufacturing.

The problem addressed is solved by the process according to the invention, which is directed to producing a machine component by additive manufacturing. The process comprises a first step in which at least one material layer is provided. To this end, the material layer may be applied substantially planarly in an operating region by at least one dispensing apparatus. In a second step, the material layer is irradiated with a laser. The irradiation with the laser causes local melting of the material layer. After irradiation, the region locally melted in this way self-hardens through heat loss. In the second step, the material layer is essentially passed over and correspondingly irradiated by the laser in a pattern. The material layer applied in the first step comprises a base material.

According to the invention, the material layer also comprises a hardening agent that may be added to the base material. The hardening agent is added to the base material locally in an adjustable fashion in the first step. This addition of the hardening agent is adjustable to the extent that it is specifiable how much hardening agent is added to the material layer of the base material at a selectable site on the surface. This in particular makes it possible to adjust the concentration gradient for the hardening agent within a plane defined by the material layer. This brings about a locally changeable fractional composition of the material layer in terms of the base material and the hardening agent. According to the invention the hardening agent is further at least embedded in the base material in the second step in which the material layer is irradiated with the laser. The local melting of the material layer, in particular of the base material, brings about a thermal/chemical and physical state in which the hardening agent is at least incorporated, i.e. embedded, in the molten base material upon solidification.

The embedding of the hardening agent in the base material brings about at least a hardening. The higher the local concentration of hardening agent, the stronger the hardening may be. This accelerates the production of a machine component which requires hardening. The adjustable addition of hardening agent makes it possible to perform the hardening of the machine component that is being produced in a specifiable manner. Regions in which increased or reduced hardening is sought may be specified essentially arbitrarily. This obviates the need for carburizing, for example, where the distribution of the carbon to be incorporated in the metal results from the diffusion behavior in the carburization atmosphere. The process according to the invention altogether provides an option which allows rapid production of hardened machine components by additive manufacturing and offers a high degree of constructional freedom due to the adjustabiiity of local hardness.

In one embodiment of the claimed process may be at least partially dissolved in the base material in the second step in which the material layer is irradiated with the laser. The thermal energy locally introduced by means of the laser allows diffusion of the embedded hardening agent into the base material. This may involve for example the incorporation of atoms of the hardening agent in elemental form into an atomic lattice of the base material. An at least partial diffusion of the hardening agent into the base material makes it possible to shorten a subsequent diffusion process.

In a further embodiment of the claimed process, a dispensing quantity of the hardening agent may be locally adjusted. To this end, a dispensing apparatus by means of which the hardening agent is added to the base material may be correspondingly controlled. For example, an opening duration, opening extent and/or conveying pressure may be adjusted on a dispensing nozzle of the dispensing apparatus. The local distribution of the hardening agent is thus specifiable via a simple parameter of a corresponding manufacturing apparatus. In addition, a layer thickness of the material layer may be adjusted in order to influence the hardness distribution to be achieved.

The process may further comprise a third step in which the machine component is hardened. To this end the machine component, which has in the first and second step been constructed from a plurality of laser-irradiated material layers, is subjected to an environment having an adjustable process temperature, for example a hardening furnace. In the third step the machine component is heated to a temperature at which a diffusion of the hardening agent dissolved in the base material occurs. Since, as outlined in the first and second steps, the distribution of the hardening agent is already selectively specifiable through locally adjustable addition to the base material, diffusion distances for the hardening agent in the base material can be shortened. A diffusion distance is to be understood as meaning the distance that the hardening agent must travel by diffusion until a desired concentration distribution in the machine component is achieved. Shortening the diffusion distance makes it possible to achieve a desired distribution/concentration distribution of the hardening agent at a reduced process duration for which the machine component is subjected to the environment having a process temperature. A shortened process duration in the diffusion also makes it possible to reduce or even avoid altogether the occurrence of edge oxidation at the surface of the machine component. In the case of toothed components, this in turn reduces the propensity for tooth base fracture or tooth flank fracture. A hardening operation, and thus the overall production of the machine component, may thus altogether be accelerated while enhancing quality. Alternatively or in addition, at identical process duration the same diffusion distance may be achieved at a reduced process temperature. This allows for an energy saving in the production of the machine component.

The hardening agent may moreover be in the form of a carbon powder or a carbon liquid. This is in particular to be understood as meaning a powder/a liquid containing elemental carbon. An example of a carbon powder may be graphite powder for example and a carbon liquid may be a liquid with graphite powder dissolved therein. Carbon powder and carbon liquid make it possible, on account of their easy meterability, to effect precise local addition of substantially elemental carbon to the base material. Carbon powder may be mixed with base material in a dispensing apparatus for base material, which is also substantially a powder. Carbon liquid in turn is bound by the pulverulent base material, so that this too realizes precise distribution of carbon on the material layer.

In a further embodiment of the claimed process, the base material may be an iron-based alloy, i.e. essentially a steel, a manganese alloy or a nickel-based alloy. Such materials are in powder form advantageously meltable by irradiation with lasers and in appropriate additive manufacturing processes result in a high-quality microstructure. Furthermore, tested and reliable additive manufacturing processes, for example selective laser melting, exist for such materials.

The claimed process, in particular the first and second step, may moreover be repeatedly performed for a plurality of material layers. This makes it possible to achieve a concentration gradient for the hardening agent not only within one plane of the material layer, but also across a plurality of material layers perpendicular to the planes thereof. A distribution of the hardening agent may thus be adjusted three-dimensionally in the machine component. Since the distribution of the hardening agent corresponds to a hardness distribution in a finished machine component, this ensures a high degree of constructional freedom for the machine component.

An intensity of the laser may also be adjustable in the claimed process, thus making it possible to specify a thermal energy introduced into the material layer. The intensity of the laser during the second step in which the material layer is irradiated may be specified in such a way that a diffusion of the hardening agent into the base material is at least initiated. This makes it possible to adjust a hardness of the machine component already during the additive manufacturing and in some cases shorten or obviate the need for a subsequent diffusion step. The constructional freedom having regard to hardness distribution achieved with the claimed process is thus further enhanced.

In a further embodiment of the claimed process the material layer may comprise a first and a second material which may form the material layer with an adjustable local distribution. This makes it possible for example to produce sections disposed essentially in the interior of the machine component that is being produced from a simple first material having only reduced suitability for hardening. By contrast, sections disposed towards the exterior of the component, for which hardening is necessary, may be produced for example from a second material well-suited for hardening. Altogether, this improves material utilization while simultaneously improving cost efficiency.

The problem addressed by the present invention is also solved by the computer program product according to the invention. The computer program product is configured for execution in a memory and a processor of a control unit and is storable in a non-volatile memory. The computer program is configured for receiving build data for additive manufacturing of a machine component which also comprises information about locally desired hardnesses of the machine component. The computer program product is also configured for determining commands therefrom that may be issued to a dispensing apparatus for a hardening agent and to a laser. The dispensing apparatus and the laser belong to a manufacturing apparatus for additive manufacturing, for example a unit for selective laser melting. The computer program product is configured for executing at least one of the processes outlined hereinabove. The computer program product may be configured as software or may be hard-wired or may be a combination of both. Hard-wired is to be understood as meaning for example a chip, an integrated circuit or an FPGA. The computer program product may moreover be monolithic or modular in design. Monolithic is to be understood as meaning that the computer program product may be executed on one hardware platform alone. Modular is to be understood as meaning that the computer program comprises at least two subprograms that may be executed on different hardware platforms and which in proper operation combine to implement the process via a datalink. This may be realized for example by a control unit in a manufacturing apparatus which is provided with a subprogram and is connected for example to a computer cloud, in which a further subprogram is executed.

The problem addressed is likewise solved by the control unit according to the invention. The control unit comprises a processor and a memory which are configured for controlling a manufacturing apparatus. According to the invention, the control unit is provided with a computer program product according to any of the aforementioned embodiments. Alternatively or in addition, the control unit may be configured for executing at least one embodiment of the process outlined above.

The problem addressed is also solved by the manufacturing apparatus according to the invention which comprises a dispensing apparatus for a base material suitable for additive manufacturing. The manufacturing apparatus also comprises a dispensing apparatus for a hardening agent that may be added to the base material. The manufacturing apparatus further comprises a laser by means of which the base material may be locally melted. The manufacturing apparatus is altogether configured for additive manufacturing of machine components. According to the invention the manufacturing apparatus is provided with a control unit configured according to any of the aforementioned embodiments.

The problem addressed is also solved by a machine component comprising a base material joined by irradiation with a laser. This is to be understood as meaning that the base material is converted from a pulverulent state into a cohesive workpiece by irradiation with a laser. This may be the case for example when the machine component is produced by additive manufacturing, in particular by selective laser melting. Dissolved in the base material is a hardening agent by means of which a hardness of the machine component is locally specified. Dissolved is to be understood as meaning for example that the atoms of the hardening agent are incorporated in an atomic lattice of the base material. The machine component comprises a first region having a first hardness. The machine component further comprises a second region having a second hardness. The first and second region are adjacent. This results in a transition from the first hardness to the second hardness along a common boundary between regions. The transition from the first hardness to the second hardness is essentially in the form of a discrete step. Such a discrete step may be produced for example by a process according to any of the embodiments outlined above. The diffusion distances for the hardening agent in the machine component are shortened, thus in turn allowing high concentration gradients for the hardening agent. This in turn results in substantially stepwise hardness transitions in the machine component. However, the machine component according to the invention may also be any other machine component requiring hardening during manufacturing by known processes.

The claimed machine component may further be in the form of an externally toothed gear, an internally toothed gear or a toothed rack. The machine component may in particular also be in the form of any other toothed component. In the production of such machine components hardness and the distribution thereof over the machine component is a key aspect of construction. A corresponding machine component is thus readily adaptable to the particular constructional requirements via essentially arbitrarily specifiable distribution of hardness. This especially makes it possible to forestall tooth base fracture and tooth flank fracture. The claimed machine component therefore exhibits enhanced mechanical performance and increased service life, and thus reliability.

The invention is hereinbelow more particularly elucidated with reference to individual embodiments in figures. The figures are to be understood as supplementing each other to the extent that identical reference numerals in different figures have the same technical definition. The features of the individual embodiments may also be combined with one another. The embodiments shown in the figures may also be combined with the features outlined above. In particular:

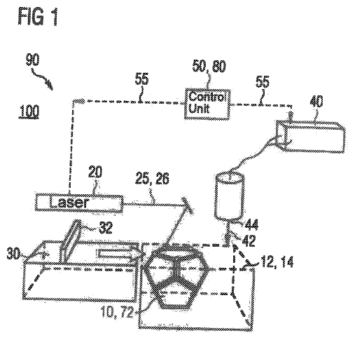

FIG. 1 is a schematic diagram showing the construction of a manufacturing apparatus for performing an embodiment of the claimed process;

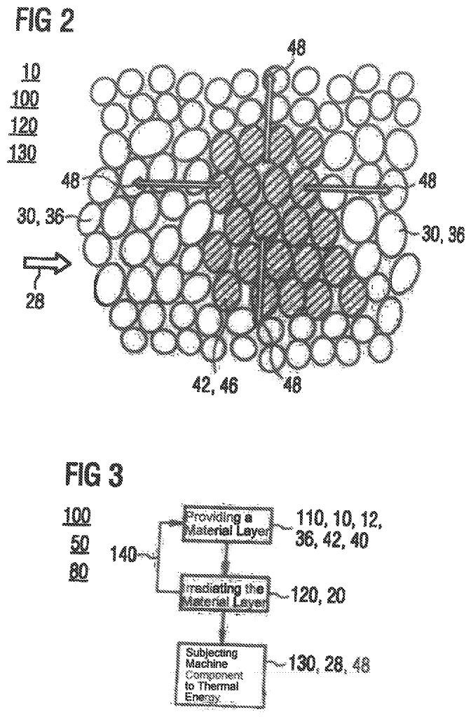

FIG. 2 is a schematic diagram showing the construction of a material layer in the course of an embodiment of the claimed process;

FIG. 3 is a schematic diagram of the sequence of an embodiment of the claimed process:

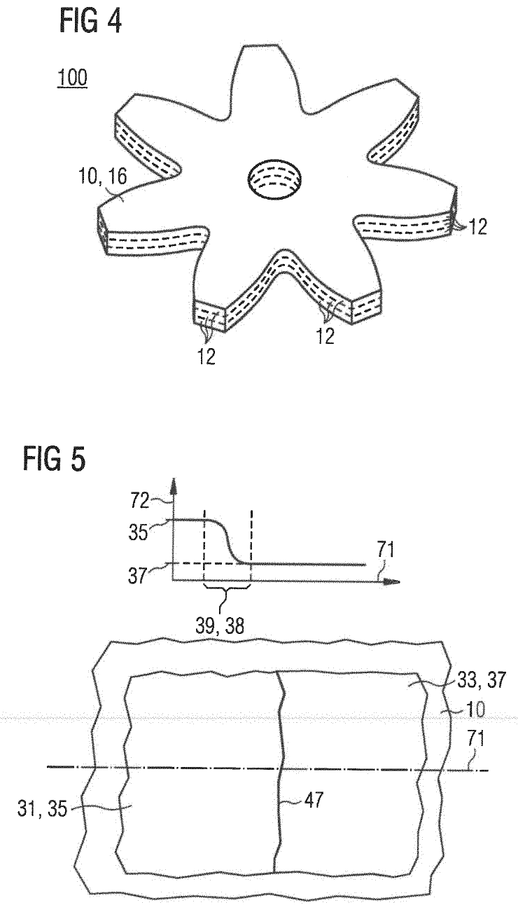

FIG. 4 is a schematic diagram of an embodiment of a claimed machine component;

FIG. 6 is a schematic view of a further embodiment of the claimed machine component.

FIG. 1 shows a schematic diagram of a construction of a manufacturing apparatus 90 with which an embodiment of the claimed process 100 may be performed. The manufacturing apparatus 90 comprises a doctor blade 32 with which a base material 30 which is substantially a metal powder may be applied in an operating region 14 in a first step 110. A hardening agent 42 is added to the base material 30 to the base material 30 with a dispensing apparatus 40 via a dispensing apparatus 40. A dispensing quantity of the hardening agent 42 may be adjusted via a dispensing nozzle 44 of the dispensing apparatus 40. The hardening agent 42 may be in the form of a carbon liquid or a carbon powder. The base material 30 and the hardening agent 42 together form a material layer 12. The dispensing apparatus 40 is movable such that a concentration of the hardening agent 42 in the plane of the material/layer 12 may be adjusted essentially arbitrarily. The totality of the material layer 12 is provided in the first step 110 of the process 100.

In a second process step 120, the material layer 12 is irradiated by a laser 20. To this end, a laser beam 25 having an adjustable intensity 26 is directed onto the material layer 12. The laser 20 effects local heating of the material layer 12, thus causing the base material 30 to melt. The laser 20 is controlled such that the irradiated material layer 12 effects further construction of a machine component 10 that is being produced. Once the laser beam 25 has passed over the material layer 12, the base material 30 solidifies and at least embeds hardening material 42. The resulting local concentration of hardening agent 42 in the molten and solidified base material 42 make it possible to adjust a hardness 72 in the machine component 10 that is being produced. In the claimed process 100, the irradiation of the material layer 12 is carried out in the second step 120. A further heat input by means of the laser 20 further makes it possible to bring about a diffusion 48 of the hardening agent 42 into the base material 30 (not shown in FIG. 1). The manufacturing apparatus 90, in particular the laser 20 and the dispensing apparatus 40, are controlled using a control unit 50 which is configured for executing commands 55. The commands 55 are generated by a computer program product 80 which is stored in the control unit 50 such that it may be executed.

FIG. 2 shows a schematic diagram of a construction of a material layer 12 such as is present during or after irradiation with a laser 20 according to a second step 120 of the claimed process 100. The material layer 12 comprises a base material 30 which is present substantially as grains 36. The hardening agent 42, which is also in the form of grains 46, is embedded in the base material 30. Thermal energy 28 introduced into the material layer 12 brings about diffusion 48 of the hardening agent 42. In FIG. 2 the hardening agent is substantially elemental carbon, which remains in the material layer 12 in the second step 120. The hardening agent 42 is incorporated into the base material 30 by the diffusion 48 and thus brings about local hardening of the base material 30. The thermal energy 28 which brings about the diffusion 48 may be supplied in the second step 120 by the laser 20 and/or in the form of process heat, for example a hardening furnace, in a third step 130. The fact that the hardening agent 42 may be applied essentially arbitrarily in the claimed process 100 means that the further diffusion distances that must be covered for a desired target state of the machine component 10 to be produced are minimized. Starting from the target state a hardening process which comprises heating and quenching may follow.

FIG. 3 shows a schematic sequence of an embodiment of the claimed process 100 with which a machine component 10 is to be produced. In a first step 110, a material layer 12 is provided. The material layer 12 comprises a base material 30 to which a hardening agent 42 is added. The hardening agent 42. Is applied to the material layer 12 using a dispensing apparatus 40. The dispensing apparatus 40 is controllable such that a dispensing quantity of the hardening agent 42 may be adjusted locally, i.e. at different positions within the plane of the material layer 12. This makes it possible to achieve essentially any desired distribution of concentrations of hardening agent 42. In a second step 120, the material layer 12 is irradiated with a laser 20 which effects local melting of the material layer 12. As a result, the hardening agent 42 is at least embedded in the base material 30. As indicated by return loop 140, the first and second steps 110, 120 are repeated until the machine component 10 that is being produced has been produced in its basic form by additive manufacturing. This is followed by a third step 130 in which the machine component 10 obtained thus far is subjected to an environment in which it is supplied with thermal energy 28, for example via a hardening furnace. This brings about diffusion 48 of the hardening agent 42 in the base material 30. This makes it possible to achieve a desired end state in the machine component 10.

An embodiment of a claimed machine component 10 is shown in FIG. 4. In particular, FIG. 4 shows an externally toothed gear 16 which is produced essentially from a plurality of material layers 12 layered on top of one another. The production of the material layers 12 is carried out with a process 100 according to any of the embodiments outlined hereinabove.

FIG. 5 shows a detailed view of a surface of a machine component 10 as shown in FIG. 4 for example. The machine component 10 comprises a first region 31 having a first hardness 35. Adjacent thereto is a second region 33 having a second hardness 37. The top of FIG. 5 further shows a diagram 70 which along the horizontal axis 71 shows a profile of the hardness 72. In the plane of the drawing. In a first region 31, the hardness 72 is essentially constant in a range of the first hardness 35. A boundary 47 marks a transition 38 of the hardness 72. The transition 38 from the range of the first hardness to the second hardness 35, 37 essentially takes the form of a step 39. The machine component 10 in FIG. 5 is produced by means of a process 100 according to one of the aforementioned embodiments. Virtually discrete spatial distributions of hardnesses 72 in the machine component 10 are achievable. The hardness 72 in the corresponding first and second regions 35, 37 is therefore selectively adaptable to constructional requirements of the machine component 10.

1.-13. (canceled)

14. A process for additive manufacturing of a machine component, said process comprising the steps of:
a) adding a hardening agent to a base material of a material layer in locally adjustable fashion, wherein addition of the hardening agent is adjustable to the extent that it is specifiable how much hardening agent is added to the material layer of the base material at a selectable site on a surface of the material layer; and
b) irradiating the material layer with a laser to effect local melting of the material layer such that the hardening agent is at least embedded in the base material as the material layer is irradiated with the laser.

15. The process of claim 14, wherein the hardening agent is at least partially dissolved in the base material.

16. The process of claim 14, wherein a dispensing quantity of the hardening agent is locally specifiable.

17. The process of claim 14, further comprising hardening the machine component to effect a diffusion of the hardening agent in the base material.

18. The process of claim 14, wherein the hardening agent is in the form of carbon powder or carbon liquid.

19. The process of claim 14, wherein the base material is an iron-based alloy, a manganese alloy or a nickel-based alloy.

20. The process of claim 14, further comprising repeatedly performing the steps a) and b) for a plurality of material layers.

21. The process of claim 14, further comprising adjusting an intensity of the laser to initiate a diffusion of the hardening agent into the base material.

22. (canceled)

23. The process of claim 14, wherein embedding of the hardening agent in the base material brings about at least a hardening.

24. The process of claim 20, further comprising hardening the machine component through exposure to thermal energy.

25. A computer program product, comprising a control unit including a non-transitory memory storing instructions to issue commands to a dispensing apparatus for a hardening agent and to a laser for executing a process as set forth in claim 14.

26. A control unit, comprising:
a processor;
a memory; and
a computer program product comprising a computer program stored in the memory and when loaded into the processor and executed by the processor causes the processor to control a manufacturing apparatus by performing the steps of
a) adding a hardening agent to a base material of a material layer in locally adjustable fashion, wherein addition of the hardening agent is adjustable to the extent that it is specifiable how much hardening agent is added to the material layer of the base material at a selectable site on a surface of the material layer; and
b) irradiating the material layer with a laser to effect local melting of the material layer such that the hardening agent is at least embedded in the base material as the material layer is irradiated with the laser.

27. A manufacturing apparatus, comprising:
a dispensing apparatus for dispensing a base material;
a dispensing apparatus for dispensing a hardening agent;
a laser for additive manufacturing of machine components; and
a control unit as set forth in claim 26.

28. A machine component, comprising:
a base material joined by irradiation with a laser;
a hardening agent dissolved in the base material;
a first region having a first hardness;
a second region adjacent to the first region and having a second hardness; and
a transition from the first hardness to the second hardness in the form of a discrete step.

29. The machine component of claim 28, constructed in the form of an externally toothed gear, an internally toothed gear or a toothed rack.
